(19) United States
(12) Patent Application Publication
(10) Pub. No.: US 2005/0046967 A1
(43) Pub. Date: Mar. 3, 2005

(54) Plastic lens and process for preparing the lens

(76) Inventors: Masahisa Kosaka, Tokyo (JP); Shinsuke Itoh, Tokyo (JP)

Correspondence Address: FINNEGAN, HENDERSON, FARABOW, GARRETT & DUNNER;LLP, 1300 I STREET, NW, WASHINGTON, DC, 20005, US

(21) Appl. No.: 10/910,379

(22) Filed: Aug. 4, 2004

(30) Foreign Application Priority Data
Aug. 5, 2003 (JP) 2003-287135

(51) Int. Cl. G02B 13/00; F21V 9/06

(52) U.S. Cl. 359/722; 252/588; 252/589

(57) ABSTRACT

A plastic lens and process of making it which comprises a plastic substrate comprising a benzophenone derivative represented by following general formula (I): 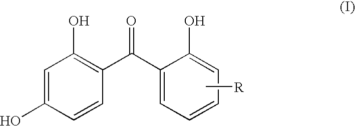 wherein R represents a linear or branched alkyl group having 2 to 12 carbon atoms or an alkoxyl group having 2 to 12 carbon atoms.

### CROSS-REFERENCE TO RELATED APPLICATION

The present application claims priority under 35 U.S.C. § 119 of Japanese Application No. 2003-287135, filed Aug. 5, 2003, the disclosure of which is expressly incorporated by reference herein in its entirety.

### FIELD OF THE INVENTION

The present invention relates to a plastic lens exhibiting excellent absorption ultraviolet light and a process for producing the lens. More particularly, the present invention relates to a plastic lens which is yellowed to a small degree even though the lens absorbs ultraviolet light having a wavelength of around 400 nm and a process for producing the lens.

### BACKGROUND OF THE INVENTION

Ultraviolet light is an electromagnetic wave having a wavelength in the range of about 200 to 400 nm and is considered to adversely affect the human health in various ways. It is increasingly desired for a spectacle lens that the lens absorbs ultraviolet light to protect the human eyes from ultraviolet light. There are various processes for providing the ability to absorb ultraviolet light to a plastic spectacle lens. As one of such processes, it is proposed that 2,2′-dihydroxy-4-methoxybenzophenone, 2,2′-dihydroxy-4-n-octoxybenzophenone or the like is mixed into a plastic lens monomer as the ultraviolet light absorbent, and a plastic lens is prepared by polymerizing the obtained plastic lens monomer. Processes of this type are described, for example, in the following Japanese Laid-Open Applications: Showa 50 (1975) 50049; Showa 58 (1983) 122501; Heisei 2 (1990) 171716; Heisei 2 (1990) 93422; and Showa 62 (1983) 254119.

However, when a lens absorbing ultraviolet light having a wavelength up to around 400 nm is produced by using a conventionally used ultraviolet light absorbent such as 2,2′-dihydroxy-4-methoxybenzophenone, 2,2′-dihydroxy-4-n-octoxybenzophenone and the like in accordance with the first process, a problem arises in that the prepared lens is markedly yellowed to cause poor appearance, in particular, when diethylene glycol bisallylcarbonate, which is the typical material for plastic spectacle lenses, is used.

A second process for providing the ability to absorb ultraviolet light to a plastic spectacle lens is performed in accordance with the same process as that for tinting a plastic lens, the plastic lens is impregnated with an ultraviolet light absorbent by dipping the plastic lens into an aqueous fluid heated at 80 to 100° C. in which the ultraviolet light absorbent is dispersed. Processes of this type are described, for example, in Japanese Laid-Open Application No. 2001-91908. It is estimated that most of the commercial plastic spectacle lenses having the property of absorbing ultraviolet light having a wavelength up to 400 nm are produced in accordance with the second process.

However, in the preparation of a plastic lens having the property of absorbing ultraviolet light having a wavelength up to around 400 nm in accordance with the second process, it is necessary that the lens be dipped for a time as long as about 40 minutes when a sufficient ability to absorb ultraviolet light is provided to the plastic spectacle lens, and this causes a decrease in productivity. To improve the productivity, it is proposed that an organic solvent is used in place of water which is conventionally used. However, there is the possibility that the plastic lens absorbing ultraviolet light having the wavelength up to about 400 nm produced in accordance with this process is more markedly yellowed.

In a third process for providing the ability to absorb ultraviolet light to a plastic spectacle lens, the surface of the plastic lens is coated with a substance absorbing and/or scattering ultraviolet light. Processes of this type are described, for example, in Japanese Laid-Open Application No. Heisei 9 (1997) 265059. However, the third process has problems in that, when the layer absorbing ultraviolet light is formed, there are possibilities that scratch resistance of the lens is insufficient and that the formed coating film of the layer tends to be cleaved.

### SUMMARY OF THE INVENTION

The present invention provides a lens which does not exhibit adverse effects on the heretofore exhibited property for absorbing ultraviolet light having a wavelength up to about 400 nm and is yellowed to a smaller degree than that of conventional plastic lenses. The present invention also provides a process for producing the above lens in which the time of the production can be decreased.

### DESCRIPTION OF THE INVENTION

The particulars shown herein are by way of example and for purposes of illustrative discussion of the various embodiments of the present invention only. In this regard, no attempt is made to show details of the invention in more detail than is necessary for a fundamental understanding of the invention, the description making apparent to those skilled in the art how the several forms of the invention may be embodied in practice.

It was found that a plastic lens exhibiting an excellent property for absorbing ultraviolet light having the wavelength up to about 400 nm and yellowed to a small degree could be obtained when a specific ultraviolet light absorbent was added to the monomer of the plastic substrate and the plastic lens was produced from the obtained mixture. The present invention provides a plastic lens which comprises a plastic substrate comprising a benzophenone derivative represented by following general formula: 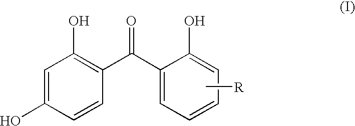
wherein R represents a linear or branched alkyl group having 2 to 12 carbon atoms or an alkoxyl group having 2 to 12 carbon atoms.

The plastic lens of the present invention does not exhibit adverse effects on the heretofore exhibited property for absorbing ultraviolet light having a wavelength up to about 400 nm and is yellowed to a smaller degree than that of conventional plastic lenses. In accordance with the process for producing a plastic lens of the present invention, the plastic lens having the above property can be efficiently produced in a decreased time of production.

It has been unknown that the compound represented by general formula (I), which is used in the present invention, can be used as the ultraviolet light absorbent when a plastic substrate, in particular, a plastic substrate using diethylene glycol bisallylcarbonate as the raw material is produced. Moreover, it has been unknown that a plastic lens which absorbs ultraviolet light having a wavelength up to about 385 nm and is yellowed to a smaller degree than that of conventional plastic lenses can be obtained when the compound represented by general formula (I) is added to a raw material and the obtained mixture is polymerized.

The benzophenone derivative represented by general formula (I) is not particularly limited. It is essential that R represents a linear or branched alkyl group having 2 to 12 carbon atoms or an alkoxyl group having 2 to 12 carbon atoms, and the effect of the present invention is exhibited within this range. R may represent a linear or branched alkyl group having 6 to 10 carbon atoms or an alkoxyl group having 6 to 10 carbon atoms. The position of the group represented by R may be any of the 3- to 6-positions, for example, the 4-position.

Examples of the benzophenone derivative represented by general formula (I) include 2,2′,4′-trihydroxy-4-ethylbenzophenone, 2,2′,4′-trihydroxy-4-propylbenzophenone, 2,2′,4′-trihydroxy-4-propylbenzophenone, 2,2′,4′-trihydroxy-4-butylbenzophenone, 2,2′,4′-trihydroxy-4-1-butyl-benzophenone, 2,2′,4′-trihydroxy-4-tert-butylbenzophenone, 2,2′,4′-tri-hydroxy-4-pentylbenzophenone, 2,2′,4′-trihydroxy-4-hexylbenzophenone, 2,2′,4′-trihydroxy-4-heptyl-benzophenone, 2,2′,4′-trihydroxy-4-octyl-benzophenone, 2,2′,4′-trihydroxy-4-tert-octylbenzophenone, 2,2′,4′-trihydroxy-4-nonylbenzophenone, 2,2′,4′-trihydroxy-4-decylbenzophenone, 2,2′,4′-trihydroxy-4-undecylbenzophenone, 2,2′,4′-trihydroxy-4-dodecyl-benzophenone, 2,2′,4′-trihydroxy-4-ethoxybenzophenone, 2,2′,4′-trihydroxy-4-propyloxybenzophenone, 2,2′,4′-trihydroxy-4-1-propyloxy-benzophenone, 2,2′,4′-trihydroxy-4-butoxybenzophenone, 2,2′,4′-trihydroxy-4-1-butyloxybenzophenone, 2,2′,4′-trihydroxy-4-tert-butyloxy-benzophenone, 2,2′,4′-trihydroxy-4-pentyloxybenzophenone, 2,2′,4′-trihydroxy-4-hexyloxybenzophenone, 2,2′,4′-trihydroxy-4-heptyloxy-benzophenone, 2,2′,4′-trihydroxy-4-octyloxybenzophenone, 2,2′,4′-trihydroxy-4-tert-octyloxybenzophenone, 2,2′,4′-trihydroxy-4-nonyloxybenzophenone, 2,2′,4′-trihydroxy-4-decyloxybenzophenone, 2,2′,4′-trihydroxy-4-undecyloxybenzophenone and 2,2′,4′-trihydroxy-4-dodecyl-oxybenzophenone.

The amount of the compound represented by general formula (I) is different depending on the type of monomer for the plastic substrate and the desired property for absorbing ultraviolet light. It is preferable that the compound represented by general formula (I) is used in an amount in the range of 0.01 to 5% by weight and for example, in the range of 0.01 to 1% by weight per the entire amount of monomer of the plastic substrate. The plastic substrate may have a YI value of 1.8 or smaller and for example, in the range of 0.7 to 1.8 at the central portion when the central portion has a thickness of 2.2 mm. The transmittance of light having a wavelength of 385 nm may be 5.0% or smaller. To obtain the plastic substrate having the above properties, the amount of the compound represented by general formula (I) may be used in the range of 0.02 to 0.20 parts by weight per 100 parts by weight of monomer for the plastic substrate, although the amount is different depending on the type of the ultraviolet light absorbent.

The resin used as the plastic substrate in the present invention is not particularly limited. Examples of the resin include poly(thio)urethane resins, sulfur-containing resins obtained by using compounds having epithio group as the raw material and resins obtained by using diethylene glycol bisallylcarbonate-based monomers as the raw material. Among these resins, the resins obtained by using diethylene glycol bisallylcarbonate-based monomers as the raw material are preferable. By adding the compound represented by general formula (I) to these resins, the substrate yellowed to a smaller degree than that of conventional substrates can be obtained easily without adverse effects on the heretofore exhibited property for absorbing ultraviolet light.

The diethylene glycol bisallylcarbonate-based monomer means diethylene glycol bisallylcarbonate alone or a mixed monomer of diethylene glycol bisallylcarbonate with monomers copolymenizable with diethylene glycol bisallylcarbonate. Examples of the monomer copolymenizable with diethylene glycol bisallylcarbonate include aromatic vinyl monomers such as styrene, α-methylstyrene, vinyltoluene, chlorostyrene, chloromethylstyrene and divinylbenzene; mono (meth)acrylates such as methyl (meth)acrylate, n-butyl (meth)acrylate, n-hexyl (meth)acrylate, cyclohexyl (meth)acrylate, 2-ethylhexyl (meth)acrylate, methoxydiethylene glycol (meth)acrylate, methoxypolyethylene glycol (meth)acrylate, 3-chloro-2-hydroxypropyl (meth)acrylate, stearyl (meth)acrylate, lauryl (meth)acrylate, phenyl (meth)acrylate, glycidyl (meth)acrylate and benzyl (meth)acrylate; mono(meth)acrylates having hydroxyl group such as 2-hydroxyethyl (meth)acrylate, 2-hydroxypropyl (meth)acrylate, 3-hydroxypropyl (meth)acrylate, 3-phenoxy-2-hydroxypropyl (meth)acrylate and 4-hydroxybutyl(meth)acrylate; di(meth)acrylates such as ethylene glycol di(meth)acrylate, diethylene glycol di(meth)acrylate, triethylene glycol di(meth)acrylate, polyethylene glycol di(meth)acrylate, 1,3-butylene glycol di(meth)acrylate, 1,6-hexanediol di(meth)acrylate, neopentyl glycol di(meth)acrylate, polypropylene glycol di(meth)acrylate, 2-hydroxy-1,3-di(meth)acryloxypropane, 2,2-bis[4-((meth)acryloxy-ethoxy)phenyl]-propane, 2,2-bis[4-((meth)acryloxy-diethoxy)phenyl] propane and 2,2-bis[4-((meth)acryloxy-polyethoxy) phenyl]propane; tri(meth)acrylates such as trimethylolpropane trimethacrylate and tetramethylolmethane trimethacrylate; tetra(meth)acrylates such as tetramethylolmethane tetra(meth)acrylate (in the present specification, a (meth)acrylate means a methacrylate or an acrylate); diallyl phthalate; diallyl isophthalate; and diallyl terephthalate. In the present invention, compounds having an aromatic ring are preferable among these compounds from the standpoint of providing a plastic spectacle lens having a great refractive index. Copolymers obtained from mixed monomers of diethylene glycol bisallylcarbonate and other monomers have been known. Examples of such copolymers include copolymens disclosed in Japanese Patent Application Laid-Open Nos. Showa 54(1979)-41965 and Showa 51(1976)-125487 and International Patent Publication (Republished in Japan) No. Heisei 01-503809. Mixtures of diethylene glycol bisallylcarbonate and monomers copolymenizable with diethylene glycol bisallylcarbonate described in the specifications of these applications are included in the diethylene glycol bisallylcarbonate-based monomer in the present invention.

The plastic substrate used in the present invention may have various properties and can be suitably selected from various substrates having different properties in accordance with the object of the use. For example, when a substrate uses diethylene glycol bisallylcarbonate as the raw material, the plastic substrate exhibiting the excellent property of absorbing ultraviolet light and preventing yellowing can be obtained by maintaining the YI value at 1.8 or smaller and, for example, in the range of 0.7 to 1.8 and the transmittance of light having a wavelength of 385 nm at 5.0% or smaller at the central portion when the central portion has a thickness of 2.2 mm.

The plastic spectacle lens of the present invention can be obtained by polymerizing the plastic lens monomer to which the compound represented by general formula (I) as the ultraviolet light absorbent is added and mixed together or by dipping the substrate formed in advance into a fluid in which the above ultraviolet absorbent is dispersed. The process for polymerizing the plastic lens monomer is not particularly limited. In general, the cast polymerization is used. When the plastic lens monomer to which the compound represented by general formula (I) as the ultraviolet light absorbent is added and mixed together is polymerized, after the compound represented by general formula (I) as the ultraviolet light absorbent and the above plastic lens monomer are mixed together, the obtained mixed fluid is cast into a mold for forming a lens, and the plastic spectacle lens is obtained by heating at a temperature in the range of −20 to 150° C. To the mixed fluid of the compound represented by general formula (I) as the ultraviolet light absorbent and the plastic lens monomer, for example, polymerization initiators such as IPP (isopropyl peroxydicarbonate), polymerization catalysts such as those described in Japanese Patent Application Laid-Open Nos. Heisei 07(1995)-063902, Heisei 07(1995)-104101, Heisei 09(1997)-208621 and Heisei 09(1997)-255781, internal mold releases such as those described in Japanese Patent Application Laid-Open Nos. Heisei 01(1989)-163012 and Heisei 03(1991)-281312, antioxidants and other auxiliary agents can be added, where necessary or desirable.

When the substrate formed in advance is dipped into a fluid in which the ultraviolet light absorbent is dispersed, in general, a fluid prepared by adding water or an organic solvent such as an alcohol to the ultraviolet light absorbent is used. Surfactants for improving dispersion of the ultraviolet light absorbent, swelling agents for swelling the plastics such as benzyl alcohol and antioxidants may be further added. The concentration of the ultraviolet absorbent in the fluid is suitably selected in accordance with the number of the lens treated for providing the property for absorbing ultraviolet light, the temperature condition, the pressure condition, the physical properties of the substrate and the desired degree of absorption of ultraviolet light and cannot be generally decided. In general, the concentration is in the range of 0.01 to 20 g per 1 liter of the fluid of the ultraviolet light absorbent. When the surfactant is added, the amount of the surfactant is not particularly limited. The amount of the surfactant is, in general, in the range of 1 to 50 ml per 1 liter of the solvent such as water. The temperature and the pressure of the fluid of the ultraviolet light absorbent are not particularly limited as long as the optical properties of the lens are not adversely affected. The temperature of the fluid may be in the range of 100 to 130° C. so that the ultraviolet light is quickly diffused within the lens. The Y1 value and the transmittance are measured at the portion having the central thickness of the lens since the Y1 value and the transmittance change depending on the central thickness.

A plastic lens obtained in accordance with the present invention can be tinted with a tinting agent. A hard coat film may be formed on the plastic lens using a coating fluid containing fine particles of an inorganic substance such as an organic silicon compound, tin oxide, silicon oxide, zirconium oxide and titanium oxide to improve resistance to scratches. A primer layer containing a polyurethane as the main component may be formed to improve impact resistance. An antireflection film may be formed using silicon oxide, titanium dioxide, zirconium oxide or tantalum oxide to provide the antireflection property. A water-repelling film may be formed on the antireflection film using an organosilicon compound having fluorine atom to improve the water-repelling property.

The present invention will be specifically described in the following with reference to examples. However, the present invention is not limited to the examples. The properties described in the following were obtained in accordance with the following methods.

(1) YI value: The Y1 value was obtained in accordance with the method for obtaining the yellow degree of plastics and the method for testing the yellowing of plastics described in Japanese Industrial Standard K7103-1977.

(2) Transmittance: The transmittance at the wavelength of 385 nm was measured by using a spectrophotometer (U3410, manufactured by HITACHI SEISAKUSHO Co., Ltd.).

### EXAMPLE 1

After 0.05 parts by weight of 2,2′,4′-tnihydroxy-4-octyloxy-benzophenone as the ultraviolet absorbent was added to 91.89 parts by weight of diethylene glycol bisallylcarbonate and dissolved to form a homogeneous solution, 11.11 parts by weight of an ethylene glycol bisallylcarbonate solution containing 27% of IPP (isopropyl peroxydicarbonate) as the polymerization initiator was added. After the obtained mixture was sufficiently mixed under stirring, the mixture was filtered through a filter of 0.2 micron to remove foreign substances in the raw material and cast into a mold for forming a lens composed of glass molds, a gasket made of a resin and a fixing spring (0.OOD; the diameter of the lens: 70 mm; the thickness of the lens: set at 2.2 mm). To cure the monomer cast into the mold, the polymerization was conducted by slowly elevating the temperature from 40° C. to 85° C. over 20 hours, followed by keeping the temperature at 85° C. for 30 minutes and lowering the temperature to 80° C. over 30 minutes while the mold was held at a position such that the face of the mold corresponding to the concave face of the lens was kept at the lower side and approximately horizontal. After the polymerization was completed, the gasket and the glass molds were disassembled, and a lens were obtained after a heat treatment (annealing) at 120° C. for 1 hour.

The obtained lens had a Y1 value of 1.55 and a transmittance of ultraviolet light having a wavelength of 385 nm of 1.0%. Thus, the lens exhibited the excellent property for reducing ultraviolet light.

### EXAMPLE 2

A lens was prepared in accordance with the same procedures as those conducted in Example 1 except that, after 0.05 pants by weight of 2,2′,4′-trihydroxy-4-octyloxybenzophenone as the ultraviolet absorbent was added to 71.89 pants by weight of diethylene glycol bisallylcarbonate and 20.00 parts by weight of methyl methacrylate and dissolved to form a homogeneous solution, 10.61 parts by weight of an ethylene glycol bisallylcanbonate solution containing 27% of IPP (isopropyl peroxydicarbonate) as the polymerization initiator was added.

The obtained lens had a YI value of 1.35 and a transmittance of ultraviolet light having a wavelength of 385 nm of 1.0%. Thus, the lens exhibited the excellent property for reducing ultnaviolet light.

### EXAMPLE 3

A lens was prepared in accondance with the same procedures as those conducted in Example 1 except that, after 0.06 parts by weight of 2,2′,4′-trihydroxy-4-octyloxybenzophenone as the ultraviolet absorbent was added to 91.89 parts by weight of diethylene glycol bisallylcarbonate and dissolved to form a homogeneous solution, 11.11 pants by weight of an ethylene glycol bisallylcanbonate solution containing 27% of IPP (isopropyl peroxydicarbonate) as the polymerization initiator was added.

The obtained lens had a YI value of 1.58 and a transmittance of ultraviolet light having a wavelength of 385 nm of 0.5%. Thus, the lens exhibited the excellent property for reducing ultraviolet light.

### EXAMPLE 4

A lens was prepared in accordance with the same procedures as those conducted in Example 1 except that, after 0.06 parts by weight of 2,2′,4′-trihydroxy-4-dodecyloxybenzo-phenone as the ultraviolet absorbent was added to 91.89 parts by weight of diethylene glycol bisallylcarbonate and dissolved to form a homogeneous solution, 11.11 pants by weight of an ethylene glycol bisallylcarbonate solution containing 27% of IPP (isopropyl peroxydicarbonate) as the polymerization initiator was added.

The obtained lens had a Y1 value of 1.75 and a transmittance of ultraviolet light having a wavelength of 385 nm of 1.1%. Thus, the lens exhibited the excellent property for reducing ultraviolet light.

### COMPARATIVE EXAMPLE 1

A plastic lens was prepared in accordance with the same procedures as those conducted in Example 1 except that 0.05 parts by weight of 2,2′,4,4′-tetrahydroxybenzophenone was used as the ultraviolet absorbent. The obtained lens had a Y1 value of 1.94 which showed yellowing and a transmittance of ultraviolet light having a wavelength of 385 nm of 1.0%.

### COMPARATIVE EXAMPLE 2

A plastic lens was prepared in accordance with the same procedures as those conducted in Example 1 except that 1.00 parts by weight of 2-hydroxy-4-methoxybenzophenone was used as the ultraviolet absorbent. The obtained lens had a YI value of 2.14 which showed yellowing and a transmittance of ultraviolet light having a wavelength of 385 nm of 0.5%.

### COMPARATIVE EXAMPLE 3

A plastic lens was prepared in accordance with the same procedures as those conducted in Example 1 except that 0.15 parts by weight of 2-(2-hydroxy-4-octyloxyphenyl) benzotriazole was used as the ultraviolet absorbent. The obtained lens had a YI value of 3.27 which showed yellowing and a transmittance of ultraviolet light having a wavelength of 385 nm of 1.9%.

### COMPARATIVE EXAMPLE 4

A plastic lens was prepared in accordance with the same procedures as those conducted in Example 1 except that 0.15 parts by weight of 2-(2,4-hydroxyphenyl)benzotniazole was used as the ultraviolet absorbent. The obtained lens exhibited a Y1 value of 3.84 which showed yellowing and a transmittance of ultraviolet light having a wavelength of 385 nm of 1.0%.

### COMPARATIVE EXAMPLE 5

A plastic lens was prepared in accordance with the same procedures as those conducted in Example 1 except that 0.08 parts by weight of 5-chloro-2-(2,4-dihydroxyphenyl)benzotriazole was used as the ultraviolet absorbent. The obtained lens had a YI value of 3.66 which showed yellowing and a transmittance of ultraviolet light having a wavelength of 385 nm of 0.5%.

### COMPARATIVE EXAMPLE 6

A plastic lens was prepared in accordance with the same procedures as those conducted in Example 1 except that 0.08 parts by weight of 2,2′-dihydroxy-4-methoxybenzophenone was used as the ultraviolet absorbent. The obtained lens had a YI value of 2.40 which showed yellowing and a transmittance of ultraviolet light having a wavelength of 385 nm of 1,2%.

### COMPARATIVE EXAMPLE 7

A plastic lens was prepared in accordance with the same procedures as those conducted in Example 1 except that 0.15 parts by weight of 2,2′-dihydroxy-4-octyloxybenzophenone was used as the ultraviolet absorbent. The obtained lens had a Y1 value of 2.22 which showed yellowing and a transmittance of ultraviolet light having a wavelength of 385 rim of 1.0%.

The physical properties of the lenses obtained in Examples 1 to 4 and Comparative Examples 1 to 7 are shown in Table 1, and the transmittance curves are shown in FIG. 1 to 11.

TABLE 1

| | | Initiator |
|---|---|---|
| | Material monomer | (part by |
| | (part by weight) | weight) |
| Example | | |
| 1 | diethylene glycol bisallylcarbonate (100) | IPP (3.0) |
| 2 | diethylene glycol bisallylcarbonate (80) | IPP (2.5) |
| | methyl methacrylate (20) | |
| 3 | diethylene glycol bisallylcarbonate (100) | IPP (3.0) |
| 4 | diethylene glycol bisallylcarbonate (100) | IPP (3.0) |
| Comparative | | |
| Example | | |
| 1 | diethylene glycol bisallylcarbonate (100) | IPP (3.0) |
| 2 | diethylene glycol bisallylcarbonate (100) | IPP (3.0) |
| 3 | diethylene glycol bisallylcarbonate (100) | IPP (3.0) |
| 4 | diethylene glycol bisallylcarbonate (ioo) | IPP (3.0) |
| 5 | diethylene glycol bisallylcarbonate (100) | IPP (3.0) |
| 6 | diethylene glycol bisallylcarbonate (100) | IPP (3.0) |
| 7 | diethylene glycol bisallylcarbonate (100) | IPP (3.0) |

| | Ultraviolet light absorbent | Transmit- | | Y1 |
|---|---|---|---|---|
| | (part by weight) | tance (%) | Appearance | value |
| Example | | | | |
| 1 | 2,2′,4′-trihydroxy-4- | 1.0 | light yellow | 1.55 |
| | octyloxybenzophenone | | transparent | |
| | (0.05) | | | |
| 2 | 2,2′,4′-trihydroxy-4- | 1.0 | light yellow | 1.35 |
| | octyloxybenzophenone | | transparent | |
| | (0.05) | | | |
| 3 | 2,2′,4′-trihydroxy'4- | 0.5 | light yellow | 1.58 |
| | octyloxybenzophenone | | transparent | |
| | (006) | | | |
| 4 | 2,2′,4′-trihydroxy-4- | 1.1 | light yellow | 1.75 |
| | dodecyloxybenzophenone | | transparent | |
| | (0.06) | | | |
| Compar- | | | | |
| ative | | | | |
| Example | | | | |
| 1 | 2,2′,4,4′- | 1.0 | yellow | 1.94 |
| | tetrahydroxybenzophenone | | transparent | |
| | (0.05) | | | |
| 2 | 2-hydroxy-4- | 0.5 | yellow | 2.14 |
| | methoxybenzophenone | | transparent | |
| | (1.00) | | | |
| 3 | 2-(2-hydroxy-4- | 1.9 | yellow | 3.27 |
| | octyloxyphenyl) | | transparent | |
| | benzotriazole (0.15) | | | |
| 4 | 2,(2,4-dihydroxyphenyl) | 1.0 | yellow | 3.84 |
| | benzotriazole (0.15) | | transparent | |
| 5 | 5-chloro-2-(2,4- | 0.5 | yellow | 3.66 |
| | thhydroxyphenyl) | | transparent | |
| | benzotriazole (0.08) | | | |
| 6 | 2,2′-dihydroxy-4- | 1.2 | yellow | 2.40 |
| | methoxybenzophenone | | transparent | |
| | (0.08) | | | |
| 7 | 2,2′-thhydroxy-4- | 1.0 | yellow | 2.22 |
| | oxtyloxybenzophenone | | transparent | |
| | (0.15) | | | |

### BRIEF DESCRIPTION OF DRAWINGS

FIG. 1 shows a diagram exhibiting the transmittance curve of the plastic lens obtained in Example 1.

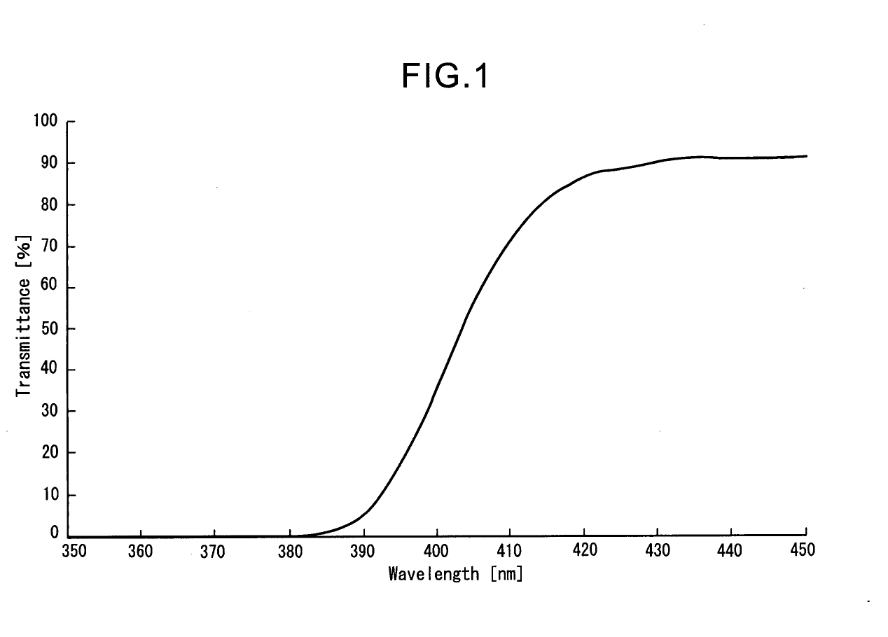

FIG. 2 shows a diagram exhibiting the transmittance curve of the plastic lens obtained in Example 2.

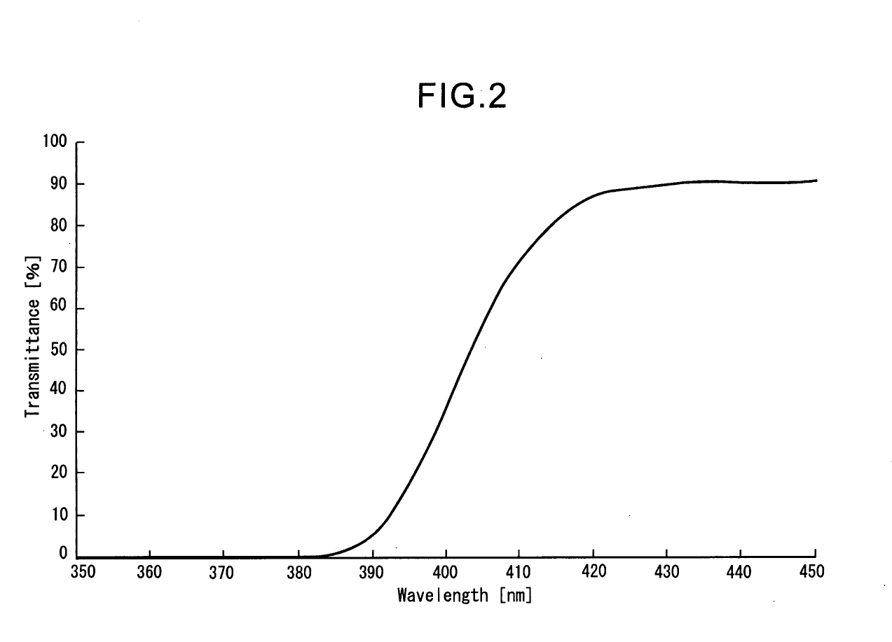

FIG. 3 shows a diagram exhibiting the transmittance curve of the plastic lens obtained in Example 3.

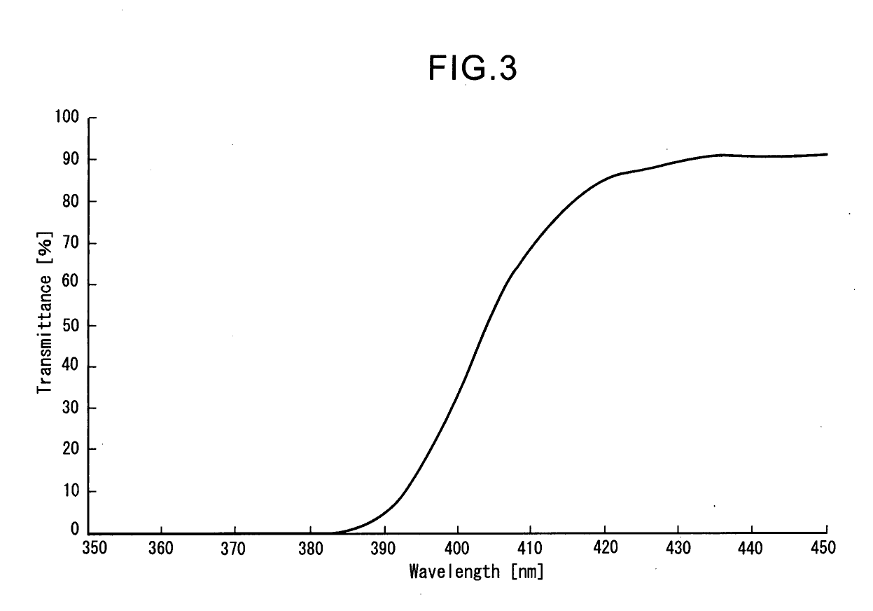

FIG. 4 shows a diagnam exhibiting the transmittance curve of the plastic lens obtained in Example 4.

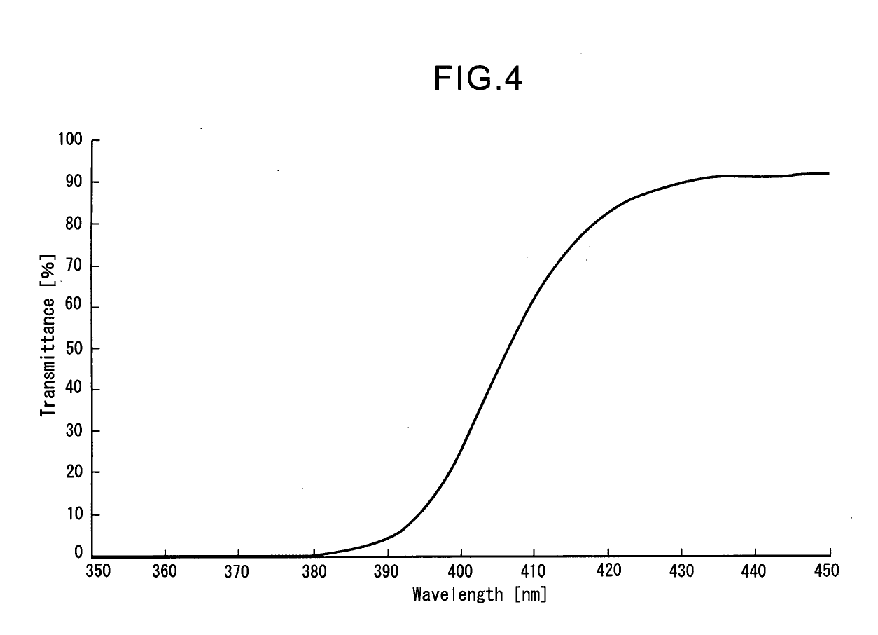

FIG. 5 shows a diagram exhibiting the transmittance curve of the plastic lens obtained in Comparative Example 1.

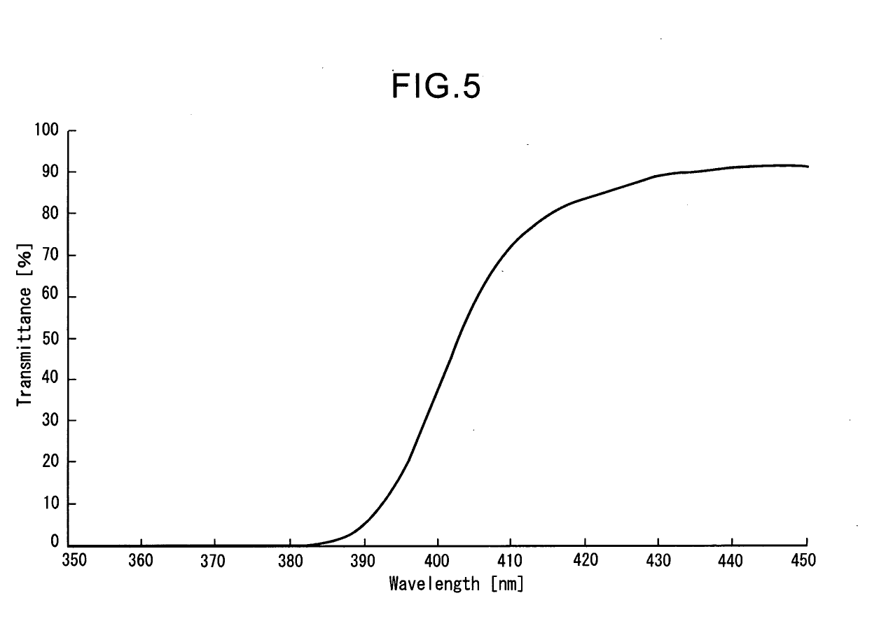

FIG. 6 shows a diagram exhibiting the transmittance curve of the plastic lens obtained in Comparative Example 2.

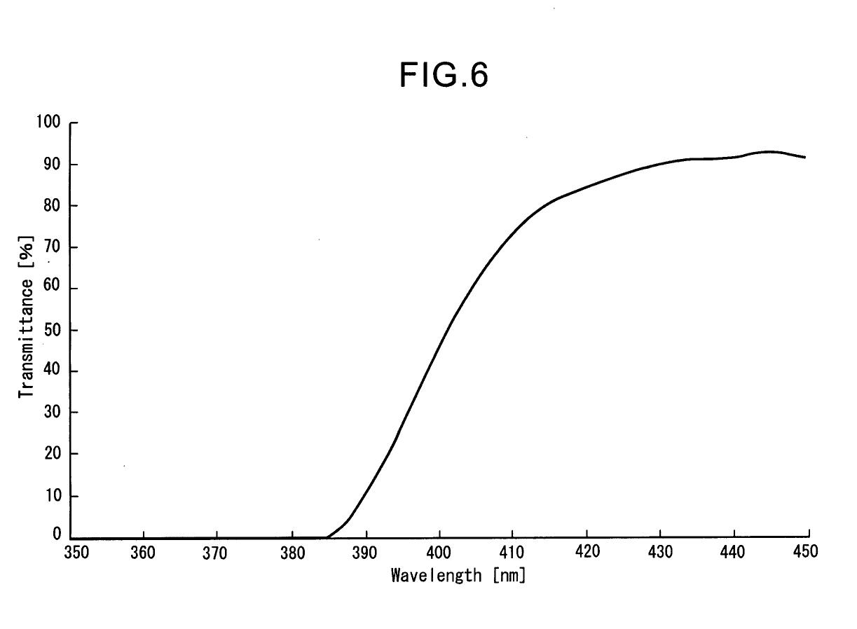

FIG. 7 shows a diagram exhibiting the transmittance curve of the plastic lens obtained in Comparative Example 3.

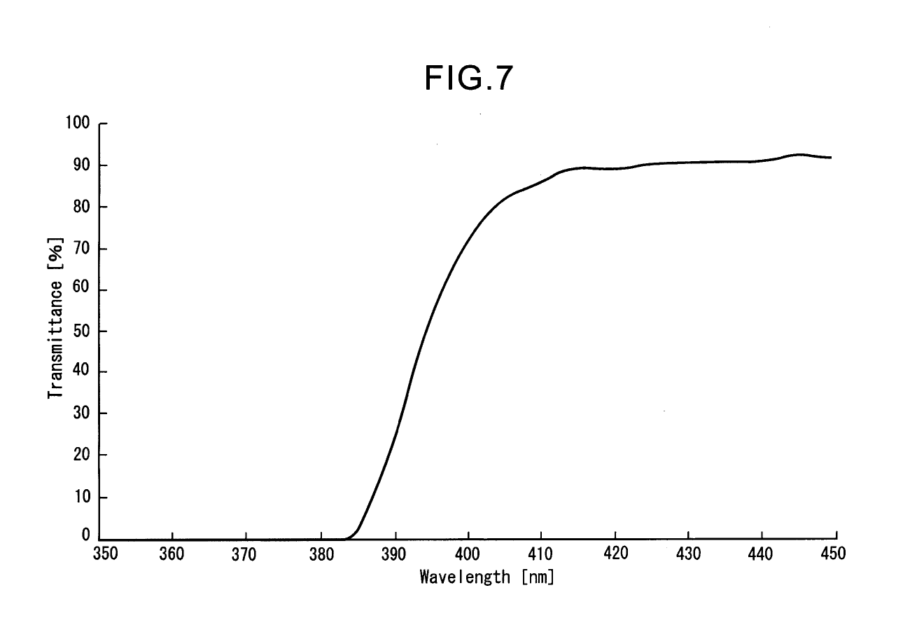

FIG. 8 shows a diagram exhibiting the transmittance curve of the plastic lens obtained in Comparative Example 4.

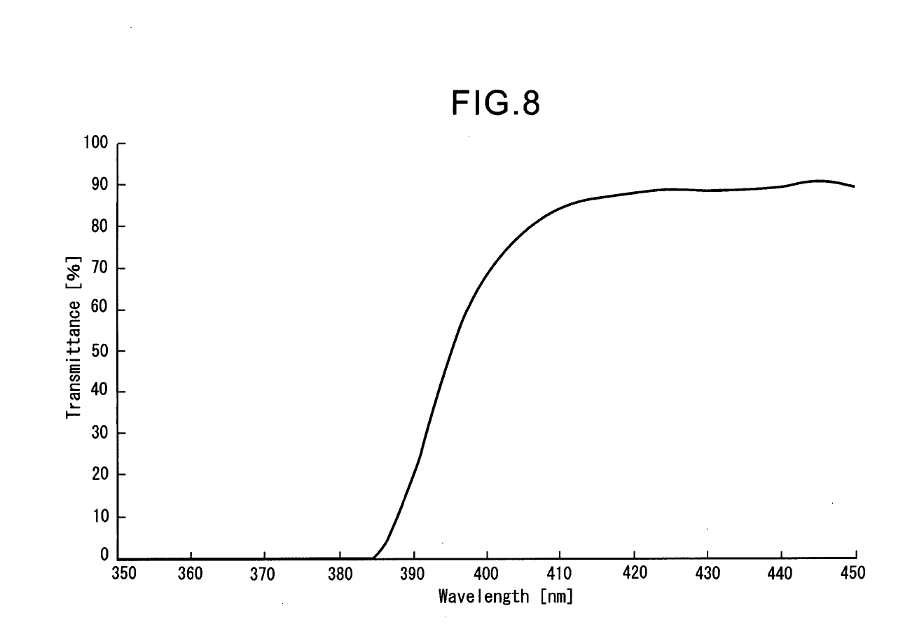

FIG. 9 shows a diagram exhibiting the transmittance curve of the plastic lens obtained in Comparative Example 5.

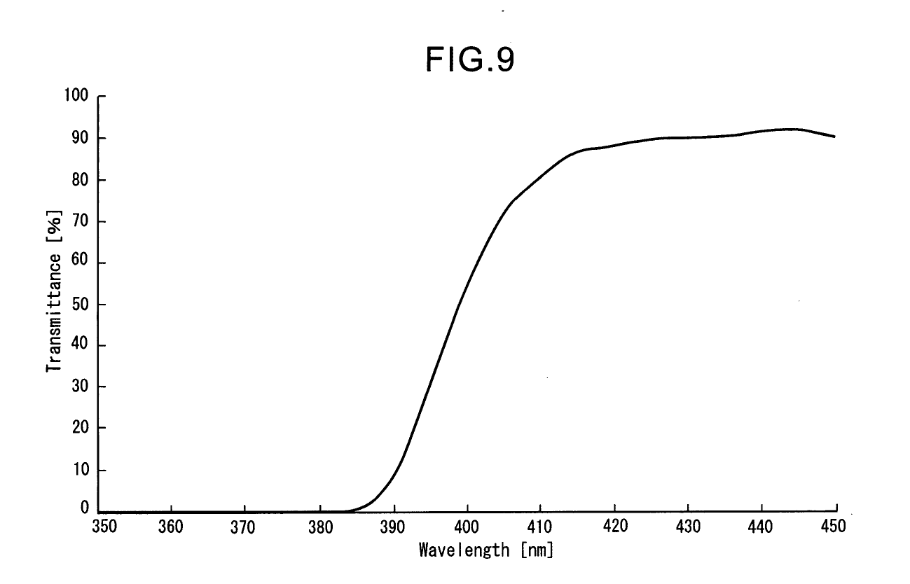

FIG. 10 shows a diagram exhibiting the transmittance curve of the plastic lens obtained in Comparative Example 6.

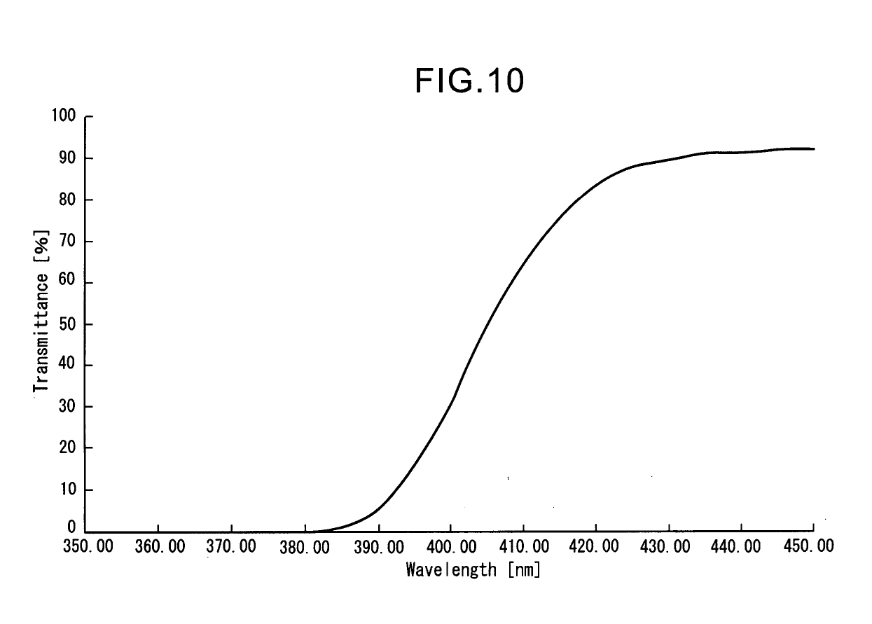

FIG. 11 shows a diagram exhibiting the transmittance curve of the plastic lens obtained in Comparative Example 7.

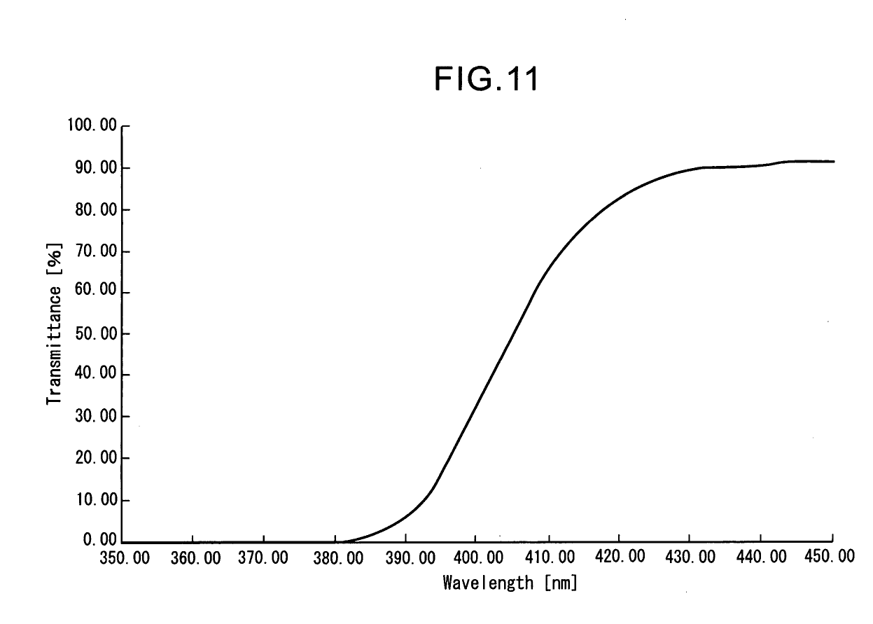

While the invention has been described in connection with certain embodiments so that aspects thereof may be more fully understood and appreciated. It is not intended to limit the invention to these particular embodiments. On the contrary, it is intended to cover all alternatives, modifications and equivalents as may be included within the scope of the invention as defined by the appended claims.

1. A plastic lens which comprises a plastic substrate and a benzophenone derivative represented by the following general formula (I): 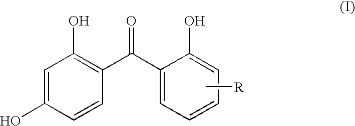
wherein R represents a linear or branched alkyl group having 2 to 12 carbon atoms or an alkoxyl group having 2 to 12 carbon atoms.

2. A plastic lens according to claim 1, wherein the benzophenone derivative represented by general formula (I) is 2,2′,4′-trihydroxy-4-octyloxybenzophenone or 2,2′,4′-trihydroxy-4-dodecyloxybenzophenone.

3. A plastic lens according to any one of claims 1 and 2, wherein the plastic substrate is a plastic substrate obtained by polymerizing a diethylene glycol bisallylcarbonate-based monomer.

4. A plastic lens according to claim 3, wherein the plastic substrate has a YI value of 1.8 or smaller and a transmittance of light having a wavelength of 385 nm of 5.0% or smaller at a central portion when the central portion has a thickness of 2.2 mm.

5. A plastic lens according to any one of claims 1 and 2, wherein the plastic substrate is coated with at least one functional film selected from a film for improving impact strength, a hard coat film, an antireflection film and a water-repelling film.

6. A process for producing a plastic lens which comprises adding to at least one monomer for a plastic substrate a benzophenone derivative represented by following general formula (I): 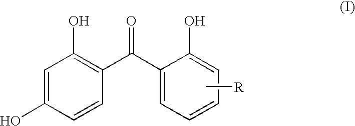
wherein R represents a linear or branched alkyl group having 2 to 12 carbon atoms or an alkoxyl group having 2 to 12 carbon atoms; and heating the material for the plastic substrate comprising the benzophenone derivative.

7. A process for producing a plastic lens according to claim 6, wherein the benzophenone derivative represented by general formula (I) is 2,2′, 4′-trihydroxy-4-octyloxybenzophenone or 2,2′,4′-trihydroxy-4-dodecyl-oxybenzophenone.

8. A process for producing a plastic lens according to any one of claims 6 and 7, wherein the at least one monomer for the plastic substrate is a diethylene glycol bisallylcarbonate-based monomer.

9. A process for producing a plastic lens according to claim 8, wherein the plastic substrate has a Y1 value in a range of 0.7 to 1.8 and a transmittance of light having a wavelength of 385 nm of 5.0% or smaller at a central portion when the central portion has a thickness of 2.2 mM.

10. A process for producing a plastic lens according to any one of claims 6 and 7, wherein the plastic substrate is coated with at least one functional film selected from a film for improving impact strength, a hard coat film, an antireflection film and a water-repelling film.
